(19) United States
(12) Patent Application Publication
(10) Pub. No.: US 2008/0220244 A1
(43) Pub. Date: Sep. 11, 2008

(54) Supercritical Fluids in the Formation and Modification of Nanostructures and Nanocomposites

(76) Inventors: Chien M Wai, Moscow, ID (US); Xiang-Rong Ye, San Diego, CA (US); Yuehe Lin, Richland, WA (US)

Correspondence Address: KLARQUIST SPARKMAN, LLP, 121 SW SALMON STREET, SUITE 1600, PORTLAND, OR, 97204, US

(21) Appl. No.: 10/585,173

(22) PCT Filed: Jan. 21, 2005
(86) PCT No.: PCT/US2005/001944

§ 371 Date: Jun. 30, 2006

Related U.S. Application Data
(60) Provisional application No. 60/538,273, filed on Jan. 21, 2004.

(51) Int. Cl. B01J 23/00; B32B 5/16; B05D 7/22

(52) U.S. Cl. 428/328; 427/230; 427/237; 502/300

(57) ABSTRACT

Embodiments of nanostructures and nanocomposites and embodiments of methods for forming and modifying these nanostructures and nanocomposites are disclosed. The methods can include transporting a metal, metallic compound or precursor to a surface of a nanostructure substrate in a carrier while the carrier is in supercritical fluid form. Embodiments of the disclosed methods can be used to form catalytic structures, such as catalytic structures including nanostructure supports and catalytic metallic nanoparticles attached to the nanostructure supports. These catalytic structures are useful for catalyzing reactions in fuel cell applications, such as oxygen reduction and methanol oxidation reactions. Some of the disclosed nanostructures and nanocomposites include carbon nanotubes.

### CROSS REFERENCE TO RELATED APPLICATION

This application claims the benefit of U.S. Provisional Application No. 60/538,273, filed on Jan. 21, 2004, which is incorporated herein by reference.

### ACKNOWLEDGEMENT OF GOVERNMENT SUPPORT

Certain disclosed embodiments were developed, at least in part, using Federal Funds provided by NSF EPSCoR contract 0132626 and by Department of Energy contract DE-AC0576RLO1830. The United States government may have rights in the claimed invention.

### FIELD

This disclosure concerns supercritical fluid chemical deposition techniques for forming and modifying nanostructures and nanocomposites.

### BACKGROUND

In recent years, increasing attention has been focused on the development of nanostructures and nanocomposites. Much of the research in this area involves carbon nanotubes. The unique geometry and other useful properties of carbon nanotubes make them potentially useful for a wide range of applications. For example, because of their small size, high chemical stability and large surface-area-to-volume ratio, carbon nanotubes have been considered as new supports for metal catalysts. Catalytically active metal nanoparticles can be introduced into the cavities of carbon nanotubes or attached onto the external walls of carbon nanotubes. In addition to serving as structural supports for metal catalysts, carbon nanotubes also can be used as templates for confining and directing the growth of nanowires.

Conventional processes for forming nanocomposites of metal and carbon nanotubes are limited in one or more key respect. One conventional process for introducing metals into the hollow interiors of carbon nanotubes involves incorporating a metal or metal precursor into the carbon source from which the carbon nanotubes are grown. Fe, Co, Ni, Ti, Cu, and certain lanthanide and transition-metal carbides have been successfully trapped in carbon nanotubes using this process. The harsh process conditions, however, including high temperatures and arc evaporation, can lead to the incorporation of impurities, such as encapsulated carbon clusters and soot. In another conventional process, melted metals are pulled into the cavities of carbon nanotubes by capillary action. This process is limited because carbon nanotubes are not wetted by liquids with surface tensions higher than about 100 to 200 mN/m. This excludes most useful materials.

Some conventional processes for introducing metals into the hollow interiors of carbon nanotubes and onto the surfaces of carbon nanotubes involve chemical reactions, including chemical reactions carried out by chemical vapor deposition (CVD) and wet chemical reactions. These processes typically require high temperatures and/or long reaction times. CVD processes are limited by the low volatility of most metal precursors. Due to the resulting low-vapor-phase concentrations of the metal precursors, CVD processes typically are mass-transfer-limited. In wet chemical processes, the capillary forces of the liquids can damage and alter fragile nanostructures. Multi-step wet chemical processes can be limited by the time required to concentrate and introduce reactants. One-step wet chemical processes, such as electroless deposition and electrodeposition, typically generate aqueous wastes and are not suitable for large-scale production. In addition, the ability of wet chemical processes to deposit metals onto the surfaces of nanostructures can be limited by the properties of these surfaces. For example, because the surfaces of carbon nanotubes are somewhat inert and poorly hydrophilic, wet chemical processes can result in poor adhesion and coverage control, as well as the undesirable formation of large metal agglomerations.

In the synthesis of catalytic structures, carbon nanotubes have only been utilized in the form of loose powders (fibers) onto which metal catalyst particles or coatings are loaded. Practical applications of such catalyst-containing nanocomposites may be hindered by several limitations. For gas-phase reactions and electrochemical reactions, the stacking and agglomeration of loose carbon nanotubes can substantially decrease the effective area of contact between catalysts and reactants. For liquid-phase reactions, the dispersion of loose carbon nanotubes in the reaction system necessitates the tedious procedure of catalyst recovery.

It is clear that existing technology for forming and modifying nanostructures and nanocomposites is inadequate. There continues to be a need for improved nanostructures and nanocomposites as well as a need for improved processes for forming and modifying nanostructures and nanocomposites.

### SUMMARY

Described herein are nanostructures, nanocomposites and methods for forming and modifying nanostructures and nanocomposites. Some of the disclosed nanostructures and nanocomposites are catalytic structures comprising nanostructure supports and catalytic metallic nanoparticles. The catalytic metallic nanoparticles can be substantially evenly distributed on the surface of the nanostructure supports. The catalytic metallic nanoparticles also can have a substantially uniform distribution of diameters with a median diameter between about 2 nm and about 12 nm. In some embodiments, the nanostructure supports comprise carbon nanotubes or nanowires. For example, the nanostructure supports can comprise a plurality of aligned carbon nanotubes attached to a common structure. The surface of the nanostructure supports, or any portion thereof, can be functionalized to promote attachment of the catalytic metallic nanoparticles. In some disclosed embodiments, the nanostructure supports comprise substantially cylindrical nanostructures with a median diameter between about 2 nm and about 100 nm. The catalytic structures can be configured to catalyze oxygen reduction or methanol oxidation in a fuel cell.

Embodiments of the disclosed methods for forming and modifying nanostructures and nanocomposites can include mixing a precursor in a carrier, such as by dissolving the precursor in the carrier, and transforming the precursor to form a metal or metallic compound. The transformation of the precursor can occur in the carrier or on the surface of a nanostructure substrate. If the transformation occurs in the carrier, the resulting metal or metallic compound can be transported to the surface of the nanostructure substrate in the carrier while the carrier is in supercritical fluid form. Similarly, if the transformation occurs on the surface of the nanostructure substrate, the precursor can be transported to the surface of the nanostructure substrate by the carrier while the carrier is in supercritical fluid form. In these embodiments, the transformation of the precursor can occur before or after separating the nanostructure substrate from the carrier. The supercritical fluid state of the carrier facilitates the delivery of materials to portions of the nanostructure substrate that are difficult to access by other means. In some embodiments, after the supercritical fluid deposition process, the resulting nanostructure or nanocomposite can be separated from the carrier by reducing the temperature and/or pressure of the carrier.

Some embodiments of the disclosed methods are well suited for the formation of catalytic structures, such as nanocomposites comprising nanostructure substrates and catalytic nanoparticles. These embodiments can include mixing a precursor in a carrier and transforming the precursor to form catalytic nanoparticles comprising a metal or metallic compound. Again, this transformation can occur in the carrier or on the surface of the nanostructure substrates. The carrier in supercritical fluid form can be used to transport the catalytic nanoparticles or precursor to the surface of the nanostructure substrates. The catalytic nanoparticles can include a variety of metals, such as Cu, Ag, Ni, Pt, Pd, Co, Au, Ir, Rh, Fe, Ru, and combinations thereof.

In some embodiments of the disclosed methods, the precursor is transformed in the carrier to form free-floating metallic nanoparticles. In these embodiments, a microemulsion can be formed by mixing the carrier with a surfactant The nanoparticles then can be deposited onto the surface of the nanostructure substrate by reducing the temperature and/or pressure of the carrier.

The carrier used in embodiments of the disclosed methods can be a gas at room temperature and atmospheric pressure. Carbon dioxide is one example of a useful carrier. The precursor can be a complex that contains the metal or metallic compound and a ligand or moiety that solubilizes the metal or metallic compound in the carrier. For example, the precursor can be a metal-β-diketone complex that is soluble in supercritical carbon dioxide. The metal or metallic compound can be released from the precursor by transforming the precursor, such as by reacting the precursor. In some disclosed embodiments, the precursor is reduced. Reduction of the precursor can be accomplished by mixing a reducing agent, such as hydrogen, into the carrier. Transformation of the precursor can occur in the presence of organic capping ligands. In some disclosed embodiments, a surface of the nanostructure substrate, such as an external surface, is functionalized to promote attachment of the metal or metallic compound. Functionalizing the surface of the nanostructure substrate can include oxidizing the surface of the nanostructure substrate.

Embodiments of the disclosed methods can be used to form a variety of nanostructures and nanocomposites. Some disclosed embodiments can be used to form nanocomposites comprising a metal or metallic compound and a nanostructure substrate on which the metal or metallic compound was formed or deposited. These nanostructure substrates can include, for example, the pores of mesoporous materials, carbon nanotubes or nanowires. Some disclosed embodiments include depositing the metal, metallic compound or precursor in a hollow interior of the nanostructure substrate, such as the hollow interior of a carbon nanotube or a pore of a mesoporous material. These embodiments can be used to form nanocomposites including nanowires or nanorods within the hollow interiors of the nanostructure substrates. To provide the resulting nanocomposites with certain useful properties, the nanostructure substrates, such as carbon nanotubes, can be attached to a common structure and substantially aligned with a plurality of similar nanostructure substrates. In some disclosed embodiments, the nanostructure substrates comprise substantially cylindrical nanostructures with a median diameter between about 2 nm and about 100 nm.

### BRIEF DESCRIPTION OF THE DRAWINGS

FIG. 1 is a schematic view of an apparatus used to perform supercritical fluid chemical deposition.

FIG. 2A is a TEM image of a Pd nanowire within a carbon nanotube.

FIG. 2B is a TEM image of a Pd nanowire within a carbon nanotube. The inset in FIG. 2B is an EDS spectrum of a Pd nanowire within a carbon nanotube.

FIG. 2C is a TEM image of a Ni nanowire within a carbon nanotube.

FIG. 2D is a TEM image of a Cu nanowire within a carbon nanotube.

FIG. 3A is a TEM image of a Pd nanorod within a carbon nanotube.

FIG. 3B is an enlargement of a portion of the TEM image shown in FIG. 3A. The insets in FIG. 3B are Fourier transform and Fourier filtered images of a portion of the image shown in FIG. 3B.

FIG. 4A is a TEM image of carbon nanotubes decorated with Pd nanoparticles deposited from 10 mg of Pd precursor.

FIG. 4B is a TEM image of carbon nanotubes decorated with Pd nanoparticles deposited from 50 mg of Pd precursor.

FIG. 5A is a TEM image of carbon nanotubes decorated with Pd nanoparticles deposited from 10 mg of Pd precursor. The inset in FIG. 5A is an EDS spectrum of a carbon nanotube decorated with Pd nanoparticles.

FIG. 5B is a TEM image of a carbon nanotube decorated with Pd nanoparticles deposited from 20 mg of Pd precursor.

FIG. 5C is a TEM image of carbon nanotubes decorated with Pd nanoparticles deposited from 30 mg of Pd precursor.

FIG. 5D is a TEM image of a carbon nanotube decorated with Pd nanoparticles deposited from 50 mg of Pd precursor.

FIG. 6 is a TEM image of carbon nanotubes decorated with Pd nanoparticles. The inset in FIG. 6 is a SAED pattern of a Pd nanoparticle.

FIG. 7A is a TEM image of carbon nanotubes decorated with Rh nanoparticles. The inset in FIG. 7A is a SAED pattern of a Rh nanoparticle.

FIG. 7B is a high-resolution TEM image of a carbon nanotube decorated with Rh nanoparticles.

FIG. 8 is a TEM image of carbon nanotubes decorated with Ru nanoparticles. The inset in FIG. 8 is a SAED pattern of a Ru nanoparticle.

FIG. 9 is a Pd_{3d} XPS spectrum of carbon nanotubes decorated with Pd nanoparticles.

FIG. 10 is a Rh_{3d} XPS spectrum of carbon nanotubes decorated with Rh nanoparticles.

FIG. 11 is a Ru_{3d} XPS spectrum of carbon nanotubes decorated with Ru nanoparticles.

FIG. 12A is a SEM image of SiO₂ nanowires decorated with Cu nanoparticles deposited from a Cu precursor at a concentration of 2.0×10⁻³ mol/L. The inset in FIG. 12A is a TEM image of a SiO₂ nanowire decorated with Cu nanoparticles.

FIG. 12B is a SEM image of SiO₂ nanowires decorated with Cu nanoparticles deposited from a Cu precursor at a concentration of 2.7×10⁻² mol/L.

FIG. 13 is a SEM image SiC nanowires decorated with Cu—Pd alloy nanoparticles.

FIG. 14 is an EDS spectrum of a SiC nanowire decorated with Cu—Pd alloy nanoparticles.

FIG. 15A is a SEM image of carbon nanotubes attached to a common structure after HNO₃ functionalization.

FIG. 15B is an enlargement of a portion of the SEM image shown in FIG. 15A.

FIG. 16 is a SEM image of carbon nanotubes attached to a common structure after HNO₃ functionalization and deposition of Pd nanoparticles.

FIG. 17 is a TEM image of carbon nanotubes after HNO₃ functionalization and deposition of Pd nanoparticles. The inset in FIG. 17 is a SAED pattern of a Pd nanoparticle.

FIG. 18A is a TEM image of functionalized carbon nanotubes decorated with Pd nanoparticles from 10 mg of Pd precursor.

FIG. 18B is a TEM image of functionalized carbon nanotubes decorated with Pd nanoparticles from 50 mg of Pd precursor.

FIG. 19A is a SEM image of unfunctionalized carbon nanotubes vertically aligned on a common structure and decorated with Pd nanoparticles.

FIG. 19B is a TEM image of unfunctionalized carbon nanotubes decorated with Pd nanoparticles.

FIG. 20 is a plot showing a series of cyclic voltammograms of oxygen reduction catalyzed by carbon-paste working electrodes containing either graphite powder, bare carbon nanotubes or Pd nanocomposites.

FIG. 21 is a cyclic voltammogram of oxygen reduction catalyzed by Pd nanocomposites on a glassy carbon electrode.

FIG. 22 is a cyclic voltammogram of oxygen reduction catalyzed Pt nanocomposites on a glassy carbon electrode.

FIG. 23 is a cyclic voltammogram of oxygen reduction catalyzed by Pt—Ru nanocomposites on a glassy carbon electrode.

FIG. 24 is a cyclic voltammogram of methanol oxidation catalyzed by Pt nanocomposites on a glassy carbon electrode.

FIG. 25 is a cyclic voltammogram of methanol oxidation catalyzed by Pt—Ru nanocomposites on a glassy carbon electrode.

### DETAILED DISCUSSION

Throughout this disclosure, the singular terms “a,” “an,” and “the” include plural referents unless the context clearly indicates otherwise. Similarly, the word “or” is intended to include “and” unless the context clearly indicates otherwise. The term “nanostructure” is used to define any structure with nanoscale features, i.e., features with key dimensions less than 1 μm. The term “nanocomposite” is used to describe any composite comprising one or more nanostructure. The terms “nanowire” and “nanorod” are used interchangeably to describe elongated nanostructures, with the former generally indicating longer nanostructures than the latter.

The following terms may be abbreviated in this disclosure: atmospheres (atm), centimeters (cm), charge-coupled device (CCD), chemical vapor deposition (CVD), diffusion reflectance infrared Fourier transform (DRIFT), energy dispersive X-ray spectrometry (EDS), grams (g), hexafluoroacetylacetonate (hfa), kiloelectronvolt (keV), metal (M), microliters (μL), micrometers (μm), milligrams (mg), milliliters (mL), millimeters (mm), milliNewtons/meter (mN/m), millivolts/second (mV/s), nuclear magnetic resonance spectroscopy (NMR), selected area electron diffraction (SAED), scanning electron microscopy (SEM), transmission electron microscopy (TEM), and X-ray photoelectron spectroscopy (XPS).

Described herein are embodiments of methods for forming and modifying nanostructures and nanocomposites using supercritical fluid carriers. Also disclosed are embodiments of improved nanostructures and nanocomposites formed or modified by the disclosed methods. Embodiments of the disclosed methods can involve the deposition of metals into small areas, such as high-aspect-ratio structures, and onto complex and/or poorly wettable surfaces. Supercritical fluids facilitate permeation, diffusion, and penetration into these areas and onto these surfaces. Using supercritical fluids, it is possible to deliver reactants and other solutes with high uniformity and homogeneity to form and modify useful nanostructures and nanocomposites, such as nanowires and metal/nanotube composites.

Supercritical fluid carriers have many additional advantages over and above the ability to access areas and surfaces that are difficult to access with conventional carriers. For example, the negligible surface tension of supercritical fluids minimizes the disruption of fragile nanostructures, such as carbon nanotubes. Supercritical fluids facilitate the formation and/or delivery of highly pure materials, in part, because unreacted materials, byproducts, and contaminants are relatively easy to remove from supercritical fluid systems. Furthermore, because supercritical fluids can hold higher concentrations of solutes than gases and have higher diffusivities than liquids, embodiments of the disclosed methods can be considerably faster than conventional processes. Some embodiments of the disclosed methods also are easier to control than conventional processes, because the solvent strength of supercritical fluids can be varied by manipulation of the temperature and/or pressure. Among other benefits, this control allows for the rapid separation of products. Finally, embodiments of the disclosed methods typically are more environmentally benign than conventional processes. Supercritical fluid chemical deposition tends to produce little or no aqueous waste. In addition, many supercritical fluids, including supercritical carbon dioxide, are non-flammable, non-toxic, recyclable and leave no residue.

### Supercritical Fluid Carriers

Supercritical fluids exhibit a hybrid of gas-like and liquid-like properties. They can dissolve solutes like a liquid and yet possesses the low viscosity, high diffusivity and zero surface tension characteristic of a gas. Supercritical fluids are miscible with gases, and their solvation power can be tuned by changing their temperature and pressure.

In some embodiments of the disclosed methods, the supercritical fluid carrier is a gas at room temperature and atmospheric pressure. Suitable supercritical fluid carriers include, but are not limited to: carbon dioxide, nitrogen, nitrous oxide, methane, ethylene, propane, propylene and mixtures thereof. The supercritical fluid carriers used in embodiments of the disclosed methods may be used individually or in combination. Carbon dioxide is a useful supercritical fluid carrier for many applications because of its relatively moderate critical temperature and pressure, and because it is non-explosive, abundantly available and relatively inexpensive.

A compound exists as a supercritical fluid when it is at a temperature and pressure above a critical temperature and pressure characteristic of the compound. The critical temperature and pressure of carbon dioxide and several other compounds that are well-suited for use as supercritical fluid carriers in some embodiments of the disclosed methods are shown in Table 1.

TABLE 1
Physical Properties of Selected Supercritical Fluids

| Fluid | Formula | T_{C} (° C.) | P_{C} (atm) |
|---|---|---|---|
| Carbon dioxide | CO₂ | 31.1 | 72.9 |
| Nitrous oxide | N₂O | 36.5 | 71.7 |
| Ammonia | NH₃ | 132.5 | 112.5 |
| n-Pentane | C₅H₁₂ | 196.6 | 33.3 |
| n-Butane | C₄H₁₀ | 152.0 | 37.5 |
| n-Propane | C₃H₆ | 96.8 | 42.0 |
| Sulfur hexafluoride | SF₆ | 45.5 | 37.1 |
| Xenon | Xe | 16.6 | 58.4 |
| Dichlorodifluoromethane | CCl₂F₂ | 111.8 | 40.7 |
| Trifluoromethane | CHF₃ | 25.9 | 46.9 |
| Methanol | CH₃OH | 240.5 | 78.9 |
| Ethanol | C₂H₅OH | 243.4 | 63.0 |
| Isopropanol | C₃H₇OH | 235.3 | 47.0 |
| Diethyl ether | (C₂H₂₅)₂O | 193.6 | 36.3 |
| Water | H₂O | 374.1 | 218.3 |

In some embodiments of the disclosed methods, a modifier is added to the supercritical fluid carrier to vary the characteristics thereof. For example, a modifier can be added to the supercritical fluid carrier to enhance the solubility of a particular solute, such as a particular reactant or product. Some useful modifiers include, without limitation: low-to-medium boiling point alcohols and esters, such as lower alkyl alcohols and esters; alkyl phosphates, typically lower alkyl phosphates, such as tributyl phosphate; and halogenated compounds, such as lower alkyl halogenated organic compounds, including methylene chloride and chloroform. Thus, typical modifiers can be selected from the group consisting of methanol, ethanol, ethyl acetate, tributyl phosphate, methylene chloride, chloroform, and combinations thereof.

The modifiers are added to the carrier in an amount sufficient to vary the characteristics thereof. This can be an amount, for example, between about 0.1% and about 20.0% by weight. The modifiers contemplated for use with embodiments of the disclosed methods most typically are not supercritical fluids at the disclosed operating conditions. Rather, the modifiers simply are dissolved in the supercritical fluid carriers to improve their properties. In some embodiments of the disclosed methods, a modifier is combined with solutes prior to introduction into a reaction vessel. Alternatively, the solutes and the modifier can be added to the reaction vessel separately.

### Deposition and Synthesis Processes

Supercritical fluids can be used to carry solutes involved in a variety of useful deposition and synthesis processes, such as the oxidation, reduction, nitriding, hydrolysis, thermal decomposition and optical decomposition of precursors to form metals or metallic compounds. Some embodiments of the disclosed methods involve supercritical fluid physical and/or chemical transformations in which the supercritical fluid acts as a medium for chemical reactions and/or for transporting solute species to various surfaces. In some cases, the supercritical fluid itself takes part in one or more chemical reaction. Precursors can be reduced by reaction with a reducing agent, such as hydrogen or boron hydride. Thermal decomposition of precursors can be achieved by heating the supercritical fluid carrier to a threshold temperature.

Precursors can be mixed with the carrier in any manner. For example, precursors can be dissolved, emulsified or suspended in the carrier. Thus “mixing,” as used herein, can include dissolving, emulsifying or suspending. In addition, precursors can be initially mixed with the carrier while the carrier is at non-supercritical fluid conditions and then the carrier can be subjected to supercritical fluid conditions.

In some disclosed embodiments, a precursor is deposited inside a cavity of a nanostructure substrate, such as a carbon nanotube, before decomposition. This can be accomplished, for example, by first soaking the nanostructure substrate in the supercritical fluid containing the precursor for a period of time sufficient to introduce the precursor into the cavity of the nanostructure substrate. Next, the system can be vented to remove the supercritical fluid. The nanostructure substrate containing the precursor then can be heated in a reducing atmosphere, such as reducing atmosphere containing hydrogen or a forming gas, such as a forming gas comprising about 95% nitrogen and about 5% hydrogen. This can cause the thermal decomposition and/or reduction of the precursor. Alternatively, the nanostructure substrate can be subjected to photo irradiation to induce decomposition of the precursor.

In some disclosed embodiments, metallic nanoparticles are formed within the supercritical fluid and then deposited on the nanostructure substrate. One example of this approach begins by mixing a surfactant, such as a perfluoropolyether surfactant, and an aqueous solution of metal salt in the supercritical fluid to form a microemulsion. A reducing agent then can be injected into the system to reduce the metal salt, thereby causing the formation of metallic nanoparticles. The microemulsion containing the metallic nanoparticles then can be pumped into a vessel loaded with the nanostructure substrate. Finally, the temperature and/or pressure can be reduced to break or de-emulsify the microemulsion and deposit the metallic nanoparticles on the surface of the nanostructure substrate.

As described in the examples below, a metal can be deposited onto the surface of a nanostructure substrate by the following reduction reaction: H₂+M(hfa)₂→M+2H(hfa), where M=metal. The supercritical fluid is used to deliver the reactants and/or products to the surfaces where metal deposition is required. By way of theory, metal nanoparticles may be nucleated on the surfaces or may be nucleated in the carrier and then delivered to the surfaces. Deposition on the reactor walls can be minimized by using a wall-cooled reactor and/or an inner heater.

Hydrogen reduction of metal-β-diketone complexes combined with deposition of the reactants or products in a supercritical fluid, such as carbon dioxide, can be used to introduce metal into high-aspect-ratio structures of inorganic and polymer nanostructure substrates, as well as into mesoporous nanostructure substrates. In some disclosed embodiments, a metal-β-diketone complex is mixed into a supercritical fluid carrier, such as supercritical carbon dioxide, and a nanostructure substrate is exposed to the solution. The nanostructure substrate can be heated before being exposed to the solution. A reducing agent, such as hydrogen, is mixed into the solution to initiate reduction of the precursor. This causes the precursor to release the metal. The reduction reaction can occur in the carrier or on an internal surface of the nanostructure substrate.

Hydrogen reduction of precursors, such as metal-β-diketone complexes, is especially useful for synthesizing sterically stabilized metal nanocrystals. In some disclosed embodiments, the deposition reactions and particle nucleation occur in the presence of organic capping ligands. By way of theory, these organic capping ligands may bind to the surfaces of the agglomerates to form monolayers that quench further growth, thereby providing size control and nanocrystal stabilization. The steric stabilization of nanocrystals in supercritical fluid varies with the tunable density and solvation power of the supercritical fluid, enabling reversible stabilization and destabilization of the colloidal dispersion. This can improve many aspects of nanocrystal processing, such as size-selective separation, synthesis, and self-assembly. By way of example, robust, highly-crystallized, relatively size-monodisperse, and sterically-stabilized Ag, Ir, and Pt nanocrystals ranging in diameter from about 2 to about 12 nm were synthesized in supercritical carbon dioxide by reducing metal-β-diketone complexes with hydrogen in the presence of fluorinated thiol ligands.

### Metals, Metallic Compounds and Precursors

Embodiments of the disclosed methods can be used to deposit metals and metallic compounds, such as metal oxides and metal nitrides. Alloys and other combinations of these metals and metallic compounds also can be deposited. Particular metals or metallic compounds can be selected to provide functional characteristics well suited for a given application. For example, in the formation of catalytic structures, metals or metallic compounds with useful catalytic properties can be selected. In the formation of electrical devices, metals or metallic compounds with desirable electrical properties can be selected. Examples of potentially useful metals and metallic compounds that can be deposited by embodiments of the disclosed methods include, but are not limited to: transition metals and transition metal compounds, such as Cu, Ag, Ni, Pt, Pd, Co, Au, Ir, Rh, Fe, Ru, TiO₂, and Ba—Sr—Ti—O. In some disclosed embodiments, the metal deposited is a Group IB or Group VIII metal on the periodic table.

As discussed above, metals and metallic compounds can be deposited by the transformation of precursors. The precursors can include metals in an oxidation state higher than zero and one or more ligands. The metal/ligand complexes also can be chelated with other moieties. The ligands and/or moieties in a precursor may be used for a variety of purposes, such as to facilitate miscibility or solubility of the precursor in the supercritical fluid carrier. Examples of ligands and moieties that may be useful in some embodiments of the disclosed methods include, without limitation: phosphates, such as triphenylphosphate, tributylphosphate (TBP), trioctylphosphate, and lower alkylphosphates; β-diketones, such as acetylacetone (AA or acac), trifluoroacetylacetone (rAA), hexafluoroacetylacetone (HFA), thenoyltrifluoroacetone (TTA), heptafluorobutanoylpivaroylmethane (FOD), and 4,4-trifluoro-1-(2-thienyl)-1,3-butanedione (HTTA); phosphine oxides, such as tributylphosphine oxide, trioctylphosphine oxide (TOPO), and triphenylphosphine oxide (TPPO); dithiocarbamates, such as bis(trifluoroethyl)dithiocarbamate (FDDC), and diethyldithiocarbamate (DDC); and crown ethers, such as “H-crown” (described in U.S. Pat. No. 5,770,085), “F2-crown” (described in U.S. Pat. No. 5,770,085), and “F6-crown” (described in U.S. Pat. No. 5,770,085). Many of these compounds can be used in their ionized or non-ionized forms.

### Selective Deposition

For certain applications, it may be useful to deposit metals onto some surfaces preferentially over other surfaces. For example, in the formation of catalytic structures including nanotubes, it may be preferable to load catalyst nanoparticles onto the exterior of the nanotubes preferentially over the interior of the nanotubes. This is because exterior nanoparticles typically are more accessible to reactant molecules than nanoparticles encapsulated inside the internal cavities of the nanotubes.

In some embodiments of the disclosed methods, selective deposition is achieved by functionalizing the surfaces of a nanostructure substrate, such as a carbon nanotube. For example, functionalization of carbon nanotubes before metal deposition can be used to facilitate the selective nucleation of metals on the outer surfaces of the carbon nanotubes with good adhesion and control. Functionalization can be accomplished, for example, by treating the nanostructure substrate with one or more oxidants, such as HNO₃, KMnO₄, OsO₄, HNO₃/H₂SO₄, RuO₄, and mixtures thereof. This results in the formation of functional groups, such as hydroxyl, carbonyl and carboxyl groups, on the external surfaces of the nanostructure substrate. These functional groups provide favored nucleation sites for metal nanoparticle growth and stabilize the nanoparticles by increasing the interaction between the nanoparticles and the surfaces of the nanostructure substrate.

As shown in the examples below, when the functionalizing step is performed on carbon nanotubes, it can result in the agglomeration of the carbon nanotubes. This significantly reduces the effective surface area for nanoparticle deposition. The agglomeration, however, also provides more secure, lock-in-place positioning of the carbon nanotubes and nanoparticles. In some cases, the bottom ends of the carbon nanotubes are secured to a common structure and the top ends of the carbon nanotubes are secured by metal aggregates. By way of theory, the agglomeration of carbon nanotubes may occur because the functional groups on the surfaces of the carbon nanotubes increase the interaction between individual carbon nanotube walls, such as by hydrogen bonding. Agglomeration of the carbon nanotubes can be avoided by depositing nanoparticles onto unfunctionalized and/or geometrically separated carbon nanotubes.

Aside from functionalization, selective deposition also can be achieved by controlling certain variables in the supercritical fluid chemical deposition process. For example, in the deposition of metal by hydrogen reduction of a precursor in supercritical carbon dioxide, it may be possible to adjust the amount of deposition by changing the precursor concentration, carbon dioxide pressure, hydrogen pressure, and/or process temperature. The nature of the deposition also can be affected by these process variables. For example, altering these process variables can affect the size of deposited nanoparticles and the degree to which a metal is deposited on the inside of a nanotube versus the outside of the nanotube. In some disclosed embodiments, the concentration of the precursor is directly proportional to the amount of metal deposited. By using a large amount of the precursor, it is possible to form catalytic structures with high surface concentrations of the catalytic metal. In the same manner it also may be possible to fully coat certain complex surfaces with metal and/or metallic compounds.

### Nanostructures and Nanocomposites

Embodiments of the disclosed methods can be used to form a wide variety of nanostructures and nanocomposites, such as nanoparticles, nanowires, nanorods, nanotubes, nanofibers, solid films with nanoscale thickness, and combinations thereof. As mentioned above, nanostructures can be any structures with nanoscale features. Some of the disclosed methods involve deposition onto nanostructure substrates. The disclosed nanostructure substrates can have nanofeatures, such as nanofeatures with dimensions less than about 500 rum, less than about 100 nm or less than about 50 nm. In some disclosed embodiments, the nanostructure substrates comprise substantially cylindrical nanostructures with median diameters between about 2 nm and about 100 nm, such as between about 5 nm and about 50 nm. Useful nanostructure substrates include, but are not limited to: nanotubes, nanorods, nanowires, nanofibers and mesoporous materials. Suitable nanotubes can be made from carbon or some other material and can be multiwalled or single-walled. Suitable nanorods, nanowires and nanofibers can be made of a variety of materials, such as carbon, SiO₂, SiC and many polymers. Some embodiments of the disclosed methods use mesoporous materials containing nanopores and/or nanochannels. These mesoporous materials can be made of materials such as silica, alumina and carbon.

In some disclosed embodiments, the nanostructure substrate comprises a polymer structure. Useful polymers include synthetic polymers and natural polymers, such as cotton and silk. Supercritical fluid can be used to swell the polymer structure to allow materials, such as metals, metal compounds and precursors, to diffuse into the polymer structure. In this way, nanoparticles can be deposited on the surfaces of the polymer structure. Dendrimers also can be useful as nanostructure substrates. Dendrimers provide large numbers of anchoring sites for nanoparticle loading. Other useful nanostructure substrates include, but are not limited to: amorphous carbon, carbon aerosols, carbon aerogels, zeolites, molecular sieves and anodized aluminum oxide. The disclosed nanostructure substrates can be functionalized or unfunctionalized.

Some disclosed embodiments can be used to form metal nanowires, nanorods and/or nanoparticles sheathed within nanotube templates, such as carbon nanotube templates. Similarly, nanowires, nanorods and/or nanoparticles can be grown inside the pores and channels of mesoporous templates, such as silica mesoporous templates and alumina mesoporous templates. For example, Pt nanoparticles can be deposited into mesoporous alumina templates by hydrogen reduction of precursors in supercritical carbon dioxide. Nanowires can be grown within hexagonal mesoporous silica by thermal decomposition of diphenylsilane in supercritical hexane. Compared to conventional processes for forming these nanostructures, embodiments of the disclosed methods typically are faster, more flexible and can be performed at lower temperatures. Metal deposited on the outer walls of nanotubes or mesoporous materials can be removed by chemical etching.

Some disclosed embodiments are useful for depositing metal nanoparticles onto complex surfaces, such as in the formation of high-surface area catalytic structures. Without support, catalytic nanoparticles are unstable and tend to agglomerate. Carbon nanotubes are particularly well-suited for supporting catalytic nanoparticles. Depositing catalytic nanoparticles on carbon nanotubes is superior in many respects to other approaches to stabilizing these nanoparticles, such as stabilization in microemulsions or stabilization with chemical stabilizers, dendrimers or polymers.

Suitable metallic nanoparticles can be used alone or in combination. Binary, ternary and higher order metallic nanoparticles may provide beneficial results for certain applications. Mixed metallic nanoparticles can be provided in a variety of forms, such as alloy and aggregate forms. The components and proportions of metallic alloy nanoparticles can be adjusted, for example, by changing the ratio of different precursors. In some disclosed nanocomposites, the nanoparticles have a substantially uniform distribution of diameters with a median diameter between about 2 nm and about 12 nm, such as between about 3 nm and about 10 nm or between about 5 nm and about 10 nm.

As disclosed in the examples below, nanoparticles comprising catalytic metals can be deposited onto the surfaces of carbon nanotubes. Nanowire composites also can be formed, such as nanowires decorated with metal nanocrystals, spherical aggregations of metal nanocrystals strung up by nanowires, nanowires wrapped in metallic shells, and mesoporous metals supported by nanowire frameworks. By way of theory, the defects in the carbon nanotube and nanowire structures may provide favored sites for nucleation and growth of the nanoparticles. In addition, the high curvature of these structures may permit the attachment of only certain sizes of nanoparticles, which prevents agglomeration. As shown in the examples below, high-density catalytic nanoparticles can be attached to both functionalized and unfunctionalized surfaces.

Unlike Pd nanoparticles loaded onto carbon nanotube powders or commercially available Pd on carbon black powders, some of the disclosed catalytic nanostructures are affixed to common structures and can be used for multiple liquid phase reactions without the need for filtration or separation. The mechanical rigidity of these nanocomposites also may be useful in continuous flow reaction systems and in chemical reactions for which vigorous agitation of the liquid reactants is desired.

In some disclosed embodiments, the nanostructure substrate comprises aligned, spaced-apart and/or geometrically-fixed nanofeatures, such as carbon nanotubes. This can overcome many of the disadvantages associated with the use of nanostructure substrates in powder form. Nanocomposites formed with nanostructure substrates including aligned, spaced-apart and/or geometrically-fixed nanostructures on a common structure can be useful for providing enhanced catalytic activity to chemical and/or electrochemical reactions, and can eliminate the need for tedious catalyst recovery processes after these reactions are complete. Aligned nanofeatures can be grown, for example, by electric field guiding mechanisms in direct current or microwave plasma CVD environments, or by crowding mechanisms in thermal CVD.

### Applications

The disclosed nanostructures and nanocomposites have a variety of uses. Some can be used as building blocks in the formation of more complex nanodevices. For example, metal/nanotube composites can be used in sensors, semiconductor devices, field emitters, scanning probe microscopes, quantum wires, storage devices for hydrogen and other gases, membrane materials for batteries and fuel cells, anodes for Li-ion batteries, capacitors, and chemical filters. They also can be used in xerography and as contrast agents in magnetic resonance imaging.

Due in part to their large surface area-to-volume ratio, many of the disclosed nanostructures and nanocomposites, such as the disclosed nanostructure substrates decorated with metallic nanoparticles, are particularly well suited for use as catalytic structures. For example, as disclosed in Examples 12-14, embodiments of the disclosed nanostructures and nanocomposites were shown to exhibit a high degree of catalytic and/or electrocatalytic activity for hydrogenation, hydroformylation, oxygen reduction, and methanol oxidation reactions. Hydrogenation and hydroformylation are examples of reactions with practical significance for chemical synthesis. Oxygen reduction and methanol oxidation are examples of reactions with practical significance for fuel cell applications. Thus, Examples 12-14 establish that the disclosed nanostructures and nanocomposites are useful for catalyzing a variety of chemical reactions, including chemical synthesis reactions and reactions useful for fuel-cell applications.

Some embodiments of the disclosed nanostructures and nanocomposites can be incorporated into fuel cells, such as proton exchange membrane fuel cells, solid oxide fuel cells, molten carbonate fuel cells, phosphoric acid fuel cells, alkaline fuel cells, direct methanol fuel cells and polymer electrolyte membrane fuel cells. For example, the disclosed nanostructures and nanocomposites can be incorporated into the electrodes of these fuel cells. Within a fuel cell, the disclosed nanostructures and nanocomposites can be used as catalytic structures for catalyzing reactions including, but not limited to: oxygen reduction, methanol oxidation and hydrogen oxidation.

### EXAMPLES

The following examples are provided to illustrate certain particular embodiments of the disclosure. Additional embodiments not limited to the particular features described are consistent with the following examples.

Among other features of the present disclosure, the following examples illustrate that embodiments of the disclosed methods can be used to deposit metals into the hollow interiors of carbon nanotubes to form nanowires and can be used to deposit nanoparticles onto the outer surfaces of nanowires and carbon nanotubes to form effective catalytic structures. It will be evident that the processes described in the following examples can be applied using a variety of different materials for variety of useful purposes.

### Example 1

### Forming Nanowires and Nanorods in Carbon Nanotubes

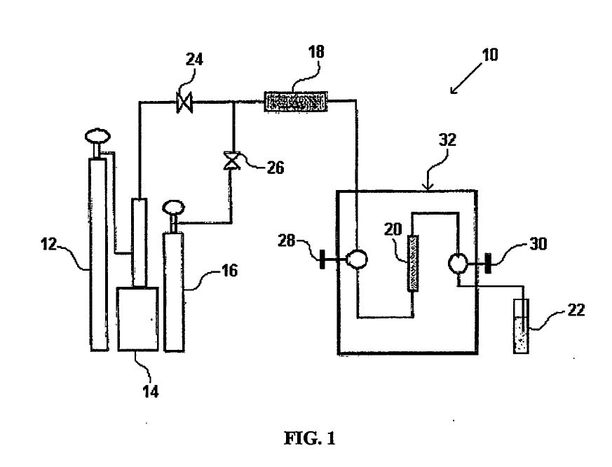

This example describes the formation of Pd, Ni, and Cu nanowires and nanorods using opened, unfunctionalized, randomly-oriented, multiwalled carbon nanotubes as templates. The depositions were carried out by hydrogen reduction of metal-β-diketone complexes in supercritical carbon dioxide. The apparatus used to perform the processes described in this example is illustrated in FIG. 1. The apparatus 10 includes a carbon dioxide source 12, a pump 14, a hydrogen source 16, a mixer 18, a reactor 20 and a collection vial 22. Flow between these elements is controlled by a first valve 24, a second valve 26, a third valve 28 and a fourth valve 30. The reactor 20, the third valve 28 and the fourth valve 30 are contained within an oven 32.

Opened, multiwalled carbon nanotubes with a purity of about 95% were obtained from NanoLab (Brighton, Mass.). These carbon nanotubes were formed by CVD processes. TEM examination revealed that most of the carbon nanotubes had hollow cores, with diameters of about 20 to 30 nm and lengths of about 2 to 3 μm. Metal chelate precursors, M(hfa)₂.xH₂O (M=Pd, Ni, and Cu) were purchased from Sigma-Aldrich (St. Louis, Mo.) and used as received.

In one trial, Pd was introduced into the carbon nanotubes. First, 10 mg of the carbon nanotubes were loaded in a 3.47 mL high pressure stainless reactor along with 10 to 50 mg of Pd(hfa)₂.xH₂O. Initially the first valve 24 was closed while the second valve 26, the third valve 28 and the fourth valve 30 were opened to allow hydrogen at 3 atm to flow through the reactor for 5 minutes. This expelled any air inside the reactor. After flushing the reactor with hydrogen, the second valve 26, the third valve 28 and the fourth valve 30 were closed, and the first valve 24 was opened to introduce carbon dioxide at 80 atm into the mixer 18. The first valve 24 then was closed and the carbon dioxide and hydrogen in the mixer 18 were mixed well by magnetic stirring. The first valve 24 and the third valve 28 then were opened to pump the carbon dioxide and hydrogen mixture into the reactor 20. The first valve 24 and the third valve then were closed. After 30 minutes, the precursor was dissolved completely in the carbon dioxide and a uniform solution was obtained. The reactor 20 then was heated gradually to 80 to 150° C. and the temperature was maintained for about 5 minutes. Next, the reactor 20 was cooled to 35° C. and vented slowly by opening the fourth valve 30. Carbon dioxide flow was used to flush the reactor 20 twice to remove any unreacted species and by-products. The reactor 20 then was opened, and the recovered powders were subjected to TEM and EDS analyses.

In additional trials, Ni and Cu were introduced into the carbon nanotubes. The apparatus, procedure and conditions for these trials were the same as those for the Pd trials, except that, in the Ni and Cu trials, the reactor 20 was heated to a higher temperature of about 250° C.

High-resolution TEM analysis of the resulting nanostructures was carried out on a Jeol JEM 2010 microscope with a routine point-to-point resolution of 0.194 nm. The operating voltage on the microscope was 200 keV. All images were digitally recorded with a slow-scan, CCD camera (image size 1024×1024 pixels). Inage processing was performed with a digital micrograph (Gatan). EDS analysis was carried out on an Oxford ISIS system attached to the Jeol 2010 TEM.

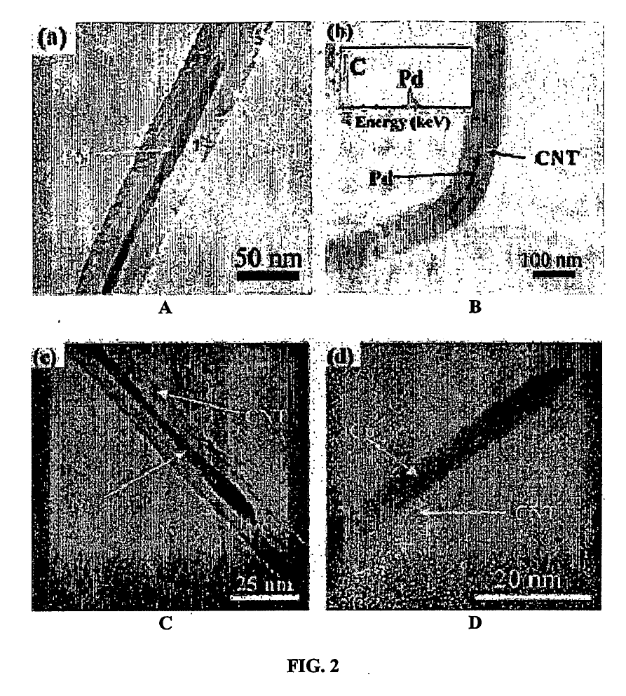

TEM observation of many different views of the products fabricated in these trials revealed several forms of foreign materials inside the carbon nanotubes. The amount of filled carbon nanotubes out of the total number of carbon nanotubes was about 10%. FIGS. 2A and 2B show TEM images of Pd nanowires sheathed within carbon nanotubes. FIGS. 2C and 2D show TEM images of Ni and Cu nanowires, respectively, sheathed within carbon nanotubes. The Pd nanowires were 7 to 9 nm in diameter and, in some cases, more than about 200 nm in full length. The diameter of the nanowires corresponded to the inner diameter of the carbon nanotubes and varied along the length of the nanowires due to fluctuation in the inner diameter of the carbon nanotubes. The nanowires were either straight or curved, depending upon the curvature of the carbon nanotubes. The inset in FIG. 2B shows an EDS spectrum of one of the Pd nanowires. It confirms that the Pd nanowire was made of substantially pure Pd.

FIG. 3A shows a high-resolution TEM image of a Pd nanorod sheathed by a carbon nanotube. This image suggests that the Pd nanorod was composed of segments of single crystals. An enlargement of the region marked by a dashed square in FIG. 3A is shown in FIG. 3B. Fourier transform and Fourier filtered high-resolution TEM images are shown as insets in FIG. 3B. The high-resolution TEM image processing indicates that the illustrated segment of the Pd nanorod had a face centered cubic structure with a measured lattice constant of 0.38 nm, which is comparable to the reported lattice constant of 0.3887 nm.

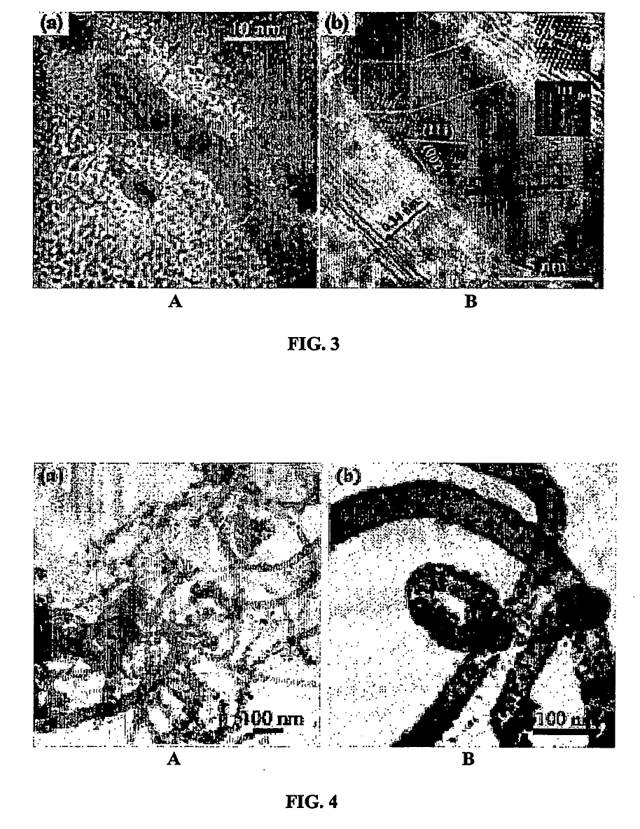

As shown in FIG. 3A, nucleation of the metals as nanoparticles on the outside of the carbon nanotubes occurred in some cases along with the metal filling. Therefore, in addition to nanowire and carbon nanotube composites, nanowire, carbon nanotube and nanoparticle composites also were observed. The TEM images in FIG. 4 show carbon nanotubes decorated with well-dispersed Pd nanoparticles. The size of the particles was about 4 to 8 nm. The Pd particles were substantially spherical, with diameters less than the diameters of the carbon nanotubes. A comparison of FIG. 4A and FIG. 4B shows how precursor concentration affected nanoparticle loading. By increasing the amount of the Pd precursor from 10 to 50 mg, while keeping other conditions identical, the loading density of the nanoparticles on the outer walls of the carbon nanotubes increased substantially. FIG. 4A shows the loading density with 10 mg of Pd precursor, while FIG. 4B shows the loading density with 50 mg of Pd precursor.

### Example 2

### Decorating Unfunctionalized, Randomly-Oriented, Multiwalled Carbon Nanotubes with Pd Nanoparticles

This example describes the deposition of Pd nanoparticles onto the outer surfaces of unfunctionalized, randomly-oriented, multiwalled carbon nanotubes using supercritical fluid chemical deposition. The apparatus, procedure and conditions for these trials were the same as those described in Example 1, except that, in these trials, the reactor was heated to about 80° C.

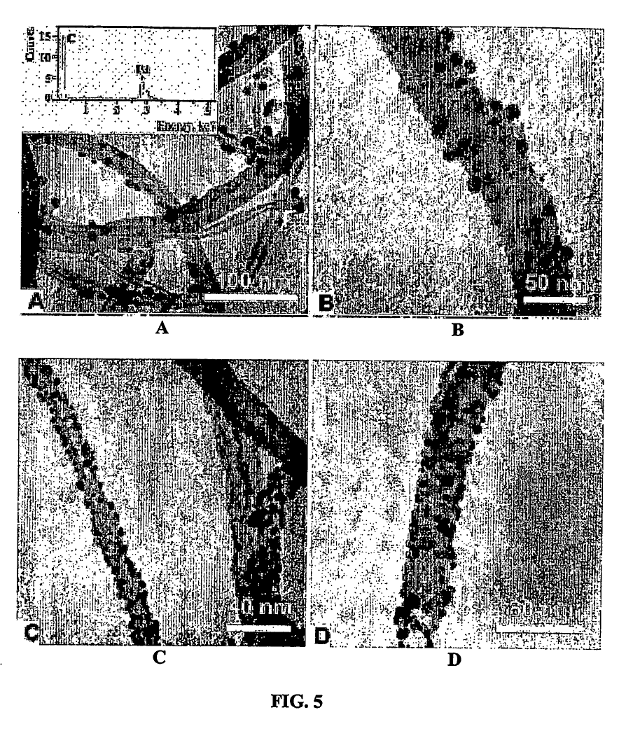

The weight gain of the carbon nanotubes due to metal loading was about 10 to 30%. FIGS. 5A, 5B, 5C and 5D show TEM images of multiwalled carbon nanotubes after Pd deposition using 10 mg, 20 mg, 30 mg and 50 mg of Pd(hfa)₂.xH₂O, respectively. Well-dispersed, spherical particles were anchored onto the external walls of the carbon nanotubes. The size range of these particles was about 5 to 10 μm. EDS examination confirmed the presence of Pd in the samples. A commercial Pd on activated carbon catalyst sample also was examined for comparison. The commercial Pd on activated carbon sample showed numerous very large Pd particles irregularly distributed on the carbon surfaces. FIGS. 5A-D show that increasing the amount of the Pd precursor caused the loading density of Pd nanoparticles on the outer walls of the carbon nanotubes to increase. FIG. 5D shows that the multiwalled carbon nanotubes were densely covered by Pd nanoparticles when 50 mg of the Pd precursor was used in the deposition process.

### Example 3

### Functionalization of Randomly-Oriented, Multiwalled Carbon Nanotubes

Functionalization of randomly-oriented, multiwalled carbon nanotubes was performed by dispersing and refluxing 0.5 g of the carbon nanotubes in 40 mL of a concentrated mixture of H₂SO₄ and HNO₃ (1:1 v/v ratio) for 6 hours to form a dark-brown suspension. The reaction mixture then was diluted with distilled water to 200 mL, stirred for several hours, cooled down to room temperature, and filtered. The recovered black solid was washed several times with distilled water and finally dried at room temperature in a vacuum. XPS and DRIFT tests revealed that the surfaces of the functionalized carbon nanotubes became covered with carboxyl, carbonyl and hydroxyl groups.

### Example 4

### Decorating Functionalized, Randomly-Oriented, Multiwalled Carbon Nanotubes with Pd Nanoparticles

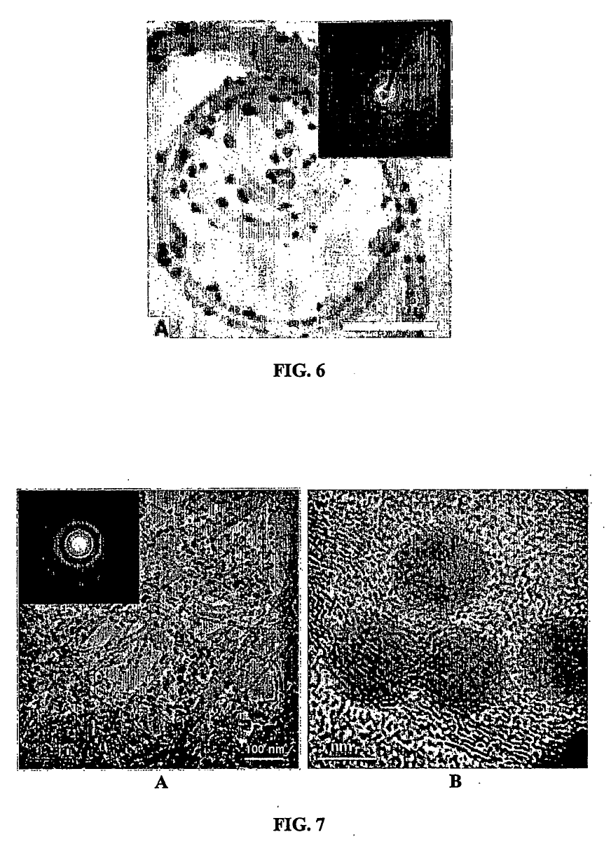

Modification of 10 mg of functionalized, randomly-oriented, multiwalled carbon nanotubes was carried out through hydrogen reduction of Pd(hfa)₂.xH₂O at 80° C. in supercritical carbon dioxide. A bright-field TEM micrograph of the carbon nanotubes after the deposition is shown in FIG. 6. Well-dispersed, spherical nanoparticles were anchored onto the external walls of the carbon nanotubes. The size range of these nanoparticles was about 5 to 10 nm. A SAED pattern of one of the Pd nanoparticles is shown as an inset in FIG. 6. The bright rings with occasional bright spots signify the crystalline nature of the Pd nanoparticle.

### Example 5

### Decorating, Functionalized, Randomly-Oriented, Multiwalled Carbon Nanotubes with Rh Nanoparticles

Modification of functionalized, randomly-oriented, multiwalled carbon nanotubes was carried out through hydrogen reduction of Rh(acac)₂.xH₂O at 250° C. in supercritical carbon dioxide. A representative TEM image of the resulting carbon nanotubes decorated with Rh nanoparticles is shown in FIG. 7A. The deposition resulted in a high and homogeneous dispersion of nanoparticles with a uniform distribution of particle diameters centered around 3 to 5 nm, which is comparable in size to the diameter of the multiwalled carbon nanotubes. As shown in the inset in FIG. 7A, SAED analysis showed that the nanoparticles were crystalline in nature. A high resolution TEM image shown in FIG. 7B verifies that the Rh nanoparticles were crystallites with visible lattice fringes.

### Example 6

### Decorating Functionalized, Randomly-Oriented, Multiwalled Carbon Nanotubes with Ru Nanoparticles

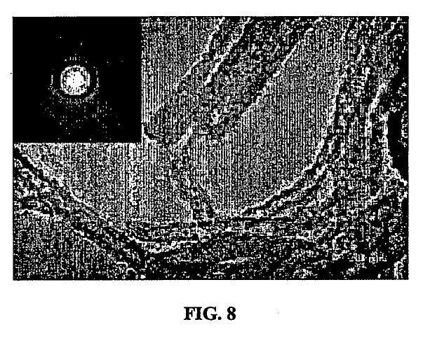

Modification of functionalized, randomly-oriented, multiwalled carbon nanotubes was carried out through hydrogen reduction of Ru(acac)₃.xH₂O at 250° C. in supercritical carbon dioxide. FIG. 8 shows a TEM image of highly dispersed Ru nanoparticles attached on the carbon nanotubes. The diameters of the nanoparticles were around 1 nm. As shown in FIG. 8, the nanoparticles were distributed uniformly over the full length of carbon nanotubes. As shown in the inset in FIG. 8, the SAED pattern exhibited a set of concentric, diffraction rings from the Ru metal. Each of these rings was made up of a large number of very small spots, suggesting that the nanoparticles were composed of many fine crystallites. An EDS spectrum of the nanocomposite showed emission from Ru, verifying that the nanoparticles contained Ru.

### Example 7

### Analyzing the Metal Nanoparticles Decorated onto Multiwalled Carbon Nanotubes

The chemical composition of the nanocomposites formed in Examples 4-6 were analyzed by XPS. For this analysis, the nanocomposites were dispersed onto silicon plates. The survey XPS spectra of the nanocomposites provided results similar to those from EDS. In addition to peaks of C, O, and Si resulting from the carbon nanotubes and background, each survey XPS spectrum showed strong peaks of the deposited metal, i.e. Pd, Rh, or Ru. No other element, including fluorine, was detected. This suggested that no byproducts or unreacted precursors were present in the nanocomposites.

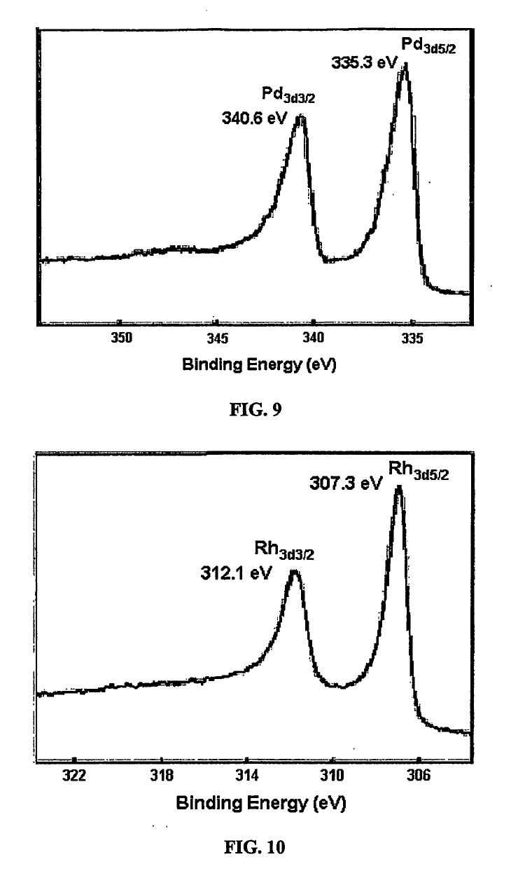

The states of the Pd, Rh, and Ru nanoparticles in the nanocomposites was identified through high-resolution XPS analysis. A typical high-resolution Pd_{3d} XPS spectrum of the Pd-decorated carbon nanotubes is shown in FIG. 9. The binding energies, 335.3 eV for the Pd_{3d5/2} speak and 340.6 eV for the Pd_{3d3/2} peak, were in accordance with those reported for Pd₀. Furthermore, the peaks were asymmetric, having a line shape typical of metallic Pd. These results imply that the Pd in the nanoparticles was zero-valent. No significant changes were observed in the binding energies or intensities of the Pd_{3d} XPS core levels after exposing the Pd-decorated carbon nanotubes to air for 1 month, which demonstrates the stability of the Pd nanoparticles.

FIG. 10 shows a high-resolution Rh_{3d} core level XPS spectrum of the carbon nanotubes coated with Rh nanoparticles. The spectrum shows a low-energy band Rh_{3d5/2} at 307.3 eV, and a high-energy band Rh_{3d3/2} at 312.1 eV. As the Rh_{3d5/2} and Rh_{3d3/2} peaks for rhodium metal lie at 307.2 and 312.0 eV, respectively, the XPS results indicate that Rh was in the zero-valent state in the nanocomposite.

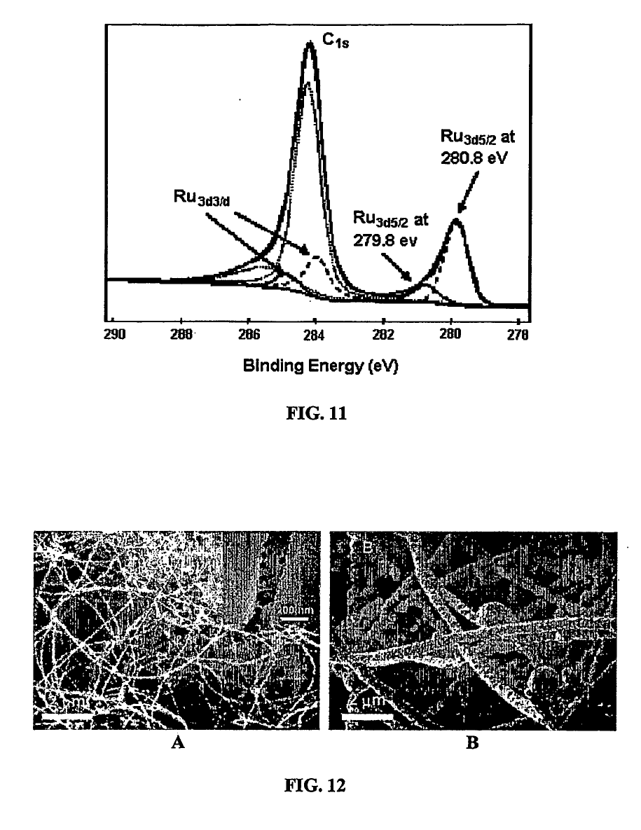

For carbon nanotubes decorated with Ru nanoparticles, the high-resolution Ru_{3d} XPS spectrum was obscured by the Cls spectrum. The deconvoluted spectrum shown in FIG. 11 gives broad bands that can be curve-fitted into two pairs of Ru_{3d} peaks. The Ru_{3d} peaks identify two chemically different Ru entities. The dominant pair with a Ru_{3d5/2} peak at 279.8 eV corresponds well with the 3d5/2 and 3d3/2 lines of element Ru₀, indicating that the majority of Ru loaded on the multiwalled carbon nanotubes was present as metallic Ru. The minor pair showing a Ru_{3d5/2} peak at 280.8 eV can be assigned to Ru oxides. The presence of Ru oxides may be responsible for the strong interaction between the highly dispersed Ru nanoparticles and oxygen-containing groups on the functionalized carbon nanotubes. The Ru oxides may have resulted from the slight oxidation of the Ru nanoparticles upon exposure of samples to ambient air.

### Example 8

### Decorating SiO₂ Nanowires with Cu Nanoparticles

This example describes the modification of SiO₂ nanowires by hydrogen reduction of Cu(hfa)₂.xH₂O in supercritical carbon dioxide. Typical SEM images of SiO₂ nanowires after Cu deposition are shown in FIG. 12. Three types of nanostructures are clearly visible in FIG. 12. When a lower precursor concentration (2.0×10^{3 -}mol/L) was used, discrete Cu nanoparticles were found to randomly anchor to the SiO₂ nanowires, as shown in FIG. 12A. When a higher precursor concentration (2.7×10⁻² mol/L) was used, the nanowires became wrapped by shells of densely packed Cu nanoparticles, as shown in FIG. 12B. The average outside diameter of the wire-shell composite structures was up to 400 nm, indicating that the shells were composed of multilayers of Cu nanoparticles. The rough surfaces of the nanocomposites suggested that the copper coating was polycrystalline. The SEM images also show aggregation of the Cu nanocrystals to form larger structures, most of which were sphere-like and strung up by the nanowires. The inset in FIG. 12A shows a TEM image of Cu nanoparticles with different sizes, ranging from several to 50 nm in diameter, strung onto a SiO₂ nanowire.

### Example 9

### Decorating SiC Nanowires with Cu—Pd Alloy Nanoparticles

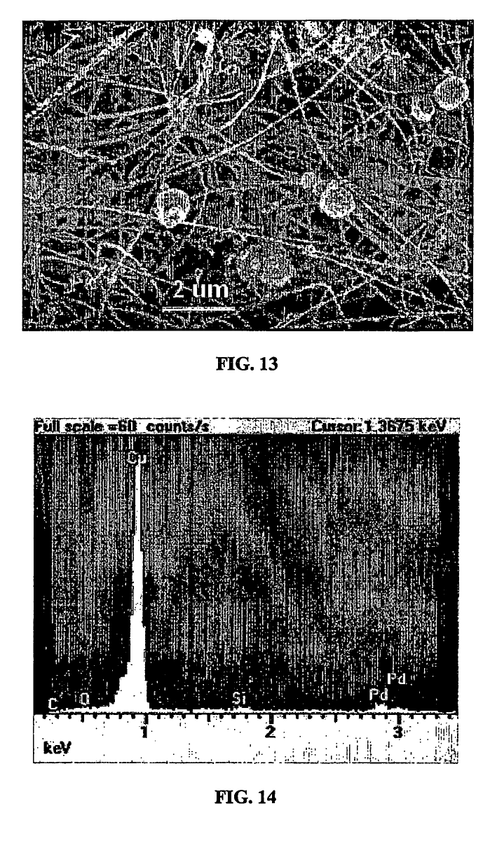

FIG. 13 shows Cu—Pd alloy nanoparticles attached to SiC nanowires through hydrogen reduction of a mixture of Cu(hfa)₂.xH₂O (95%) and Pd(hfa)₂.xH₂O (5%) in supercritical carbon dioxide at 80° C. Some aggregated balls of metal are visible. FIG. 14 is an EDS of the nanocomposite indicating the presence of Cu and Pd.

### Example 10

### Decorating Functionalized, Aligned, Multiwalled Carbon Nanotubes with Metallic Nanoparticles

This example describes the formation of nanocomposites using aligned, multiwalled carbon nanotubes. Arrays of aligned, multiwalled carbon nanotubes, grown by a CVD method on a Pt plate, were obtained from NanoLab (Brighton, Mass.) and from Prof. Z. Ren's laboratory (Boston College). Some of the carbon nanotubes were functionalized by refluxing them in 40 mL of 65% HNO₃ solution for 6 hours and then in 200 mL of 10% HNO₃ solution for several hours, followed by washing several times with distilled water and finally drying at room temperature in a vacuum.

The deposition of Pd nanoparticles onto the carbon nanotubes was carried out by hydrogen reduction of Pd(hfa)2.xH₂O. One cm² of Pt plate with carbon nanotubes was loaded into a 10 mL high-pressure, stainless-steel reactor along with 10 to 50 mg of the Pd precursor. Hydrogen at 3 atm was then allowed to flow through the reactor for 5 minutes to expel the air inside, after which carbon dioxide at 80 atm was forced into the reactor. Then the reactor was sealed and left undisturbed for 30 minutes to ensure complete dissolution of the precursor in the carbon dioxide. The reactor was then heated to 80° C. and kept at this constant temperature for 5 to 10 minutes. After the reaction, the reactor was cooled and vented, and neat carbon dioxide was used to flush the reactor twice. The nanotube sample was then removed from the system and analyzed.

The surface morphology of the nanocomposites was examined using an AMRAY 1830 SEM with an accelerating voltage of 15 to 20 kV. TEM analysis of the nanocomposites was carried out on a Jeol JEM 2010 microscope with a routine point-to-point resolution of 0.194 nm. The operating voltage of the microscope was 200 keV. All images were digitally recorded with a slow-scan CCD camera (image size 1024×1024 pixels) and image processing was carried out using a Digital Micrograph (Gatan). The TEM samples were prepared by scratching the carbon nanotubes from the common structure, dispersing them in ethanol, dropping a small amount of the slurry onto a holey carbon-coated copper grid and then drying. EDS analysis was performed on an Oxford ISIS system attached to the Jeol 2010 TEM.

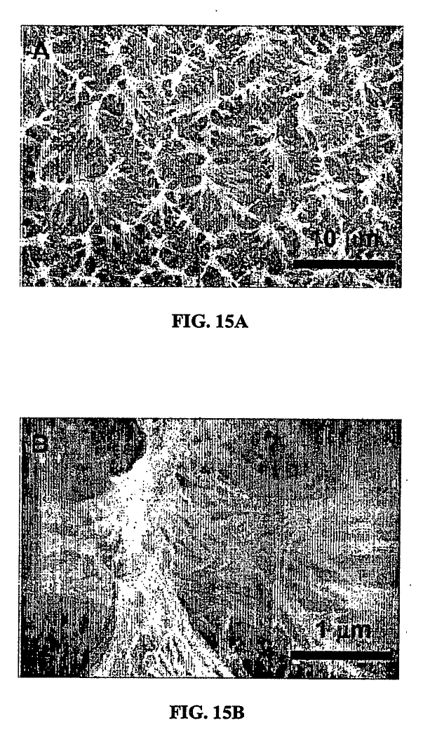

Most of the as-grown carbon nanotubes had an average diameter of about 50 nm and a length of about 10 μm, with a site density of about 1×10⁹ nanotubes/cm². The carbon nanotubes were aligned vertically on the common structure, and were separate from each other, in part, because of the separation of the catalyst particles on the common structure. After the HNO₃ functionalization process, the carbon nanotubes were still rooted on the common structure, however, as a result of the wet processing, the upper ends of neighboring carbon nanotubes tended to bundle together and form tree-like structures, as shown in FIG. 15A. A SEM image at a higher magnification, show as FIG. 15B, indicates that most of the carbon nanotubes were no longer perpendicular to the common structure after the functionalization process. The carbon nanotubes leaned over on each other, and some portions of the carbon nanotubes even became flat on the common structure.

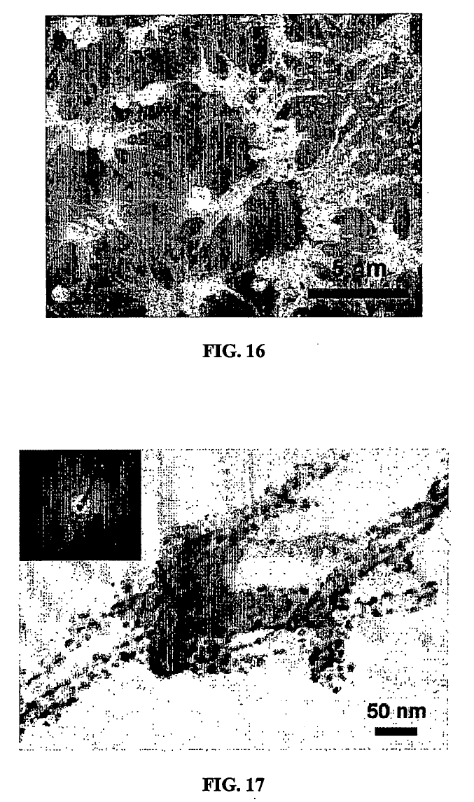

After subsequent Pd deposition on the functionalized nanotubes, the tree-like, bundled nanotube configuration was essentially retained, as shown in FIG. 16. On the top of each tree-like structure, the aggregated Pd nanoparticles formed sphere-like structures that held the nanotube ends together. The sphere-like structures had diameters between about 0.5 and about 1 μm.

The TEM image in FIG. 17 shows that numerous Pd nanoparticles, about 5 to 10 nm in diameter, and aggregates of Pd nanoparticles attached onto the walls of the carbon nanotubes. Because the functionalization caused bundling of the carbon nanotubes and also enhanced particle adhesion, many of the nanoparticles and nanoparticle aggregates were attached to more than one of the carbon nanotubes. The SAED pattern of one of the nanoparticles is shown as an inset in FIG. 17. The bright rings with occasional bright spots signify the crystalline nature of the deposited Pd nanoparticles. An EDS analysis confirmed that the nanoparticles were Pd.

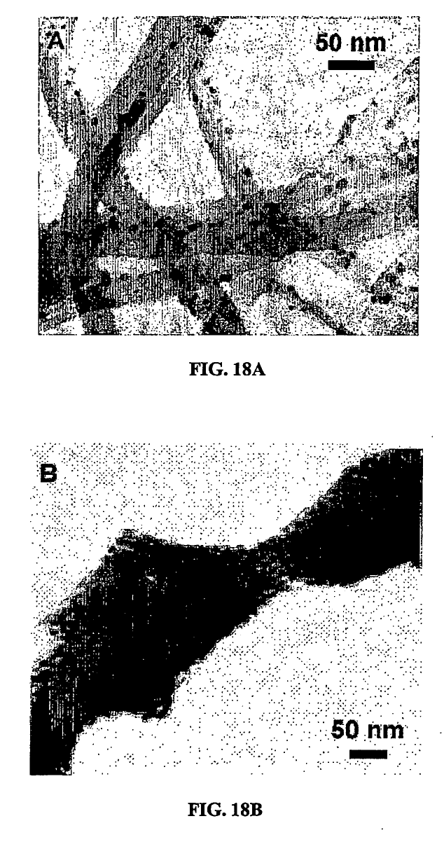

FIGS. 18A and 18B show that increasing the concentration of the precursor in the supercritical carbon dioxide solution can increase the loading density of the nanoparticles. FIG. 18A shows that functionalized, multiwalled carbon nanotubes treated with 10 mL of a supercritical carbon dioxide solution containing only 10 mg of Pd(hfa)₂.xH₂O were decorated with sparsely scattered nanoparticles. By increasing the precursor concentration to 50 mg in 10 mL of supercritical carbon dioxide, a much higher density of Pd nanoparticles was achieved. As shown in FIG. 18B, the nanoparticle density was high enough to completely wrap the surface of nanotubes.

### Example 11

### Decorating Unfunctionalized, Aligned, Multiwalled Carbon Nanotubes with Metallic Nanoparticles

This example describes the formation of nanocomposites without bundling of the carbon nanotubes. Since the supercritical fluid processing allows a substantial degree of Pd nanoparticle adhesion even without functionalization, an as-grown carbon nanotube array was subjected to the supercritical carbon dioxide deposition of Pd nanoparticles described in Example 10 without an intervening functionalization step. The precursor concentration was 30 mg of Pd(hfa)₂ in 10 mL of supercritical carbon dioxide solution.

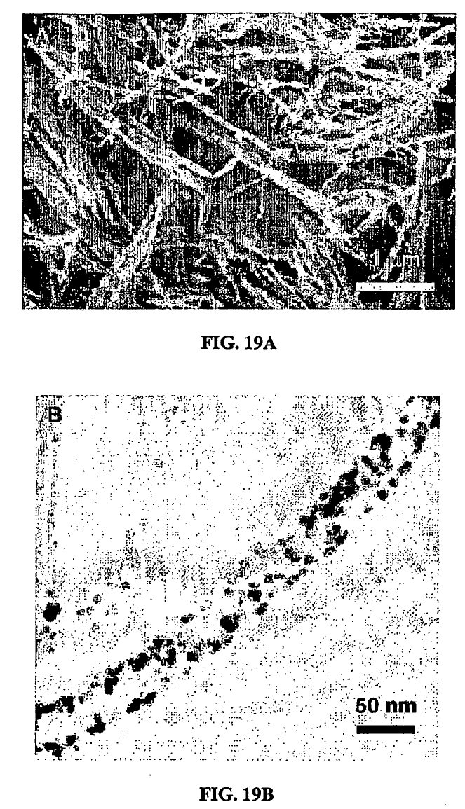

FIG. 19A is a SEM image of the resulting array of carbon nanotubes vertically aligned on a common structure. It is clear from FIG. 19A that extensive nanotube bundling did not occur. A typical bright-field TEM micrograph of the carbon nanotubes is shown in FIG. 19B. Well-dispersed, spherical particles, about 5 to 10 nm in diameter, were attached onto the external walls of the carbon nanotubes. Due to the combination of high dispersion of the Pd nanoparticles and alignment of the carbon nanotubes, a high surface area of catalyst nanoparticles was achieved.

### Example 12

### Testing the Catalytic Capability of Unfunctionalized, Randomly-Oriented, Multiwalled Carbon Nanotubes Decorated with Pd Nanoparticles in Hydrogenation and Oxygen Reduction Reactions

This example describes a series of trials performed to test the catalytic capability of the Pd nanocomposites formed in Example 2 with 20 mg of Pd precursor, as shown in FIG. 5B. In a first trial, the Pd nanocomposites were tested for their catalytic activity in the hydrogenation of a carbon dioxide-soluble olefin trans-stilbene in liquid carbon dioxide. In this test, stilbene was dissolved in a mixture of hydrogen, introduced at 5 atm, and carbon dioxide, introduced at 100 atm, to make a 0.033 Molar solution. The solution was pumped into a 6.94 ml stainless steel vessel loaded with 5 mg of the Pd nanocomposites at room temperature (23° C.). Ultrasonication was applied to the vessel for 10 seconds to disperse the catalyst. The product was collected in CDCl₃ at different times and analyzed by proton NMR on a Bruker AMX 300. According to the NMR results, conversion of stilbene to 1,2-diphenylethane was about 80% and 96% after 5 and 10 minutes of reaction, respectively. The catalyzed reaction is represented as follows:

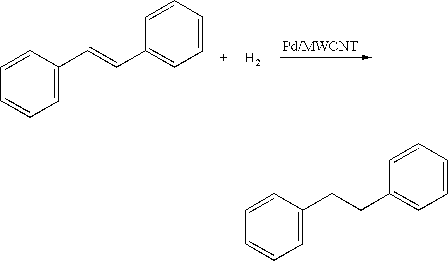

The Pd nanocomposites also were tested for their electrocatalytic activity in an oxygen reduction reaction commonly used in fuel cell applications. For comparison, three samples were tested: (1) graphite powder, (2) bare multiwalled carbon nanotubes, and (3) the Pd nanocomposites. These samples were mixed individually with mineral oil to make three different carbon-paste working electrodes. Cyclic voltammetry measurements were conducted at room temperature in a three-compartment electrochemical cell. The electrolyte was 1.0 Molar H₂SO₄ saturated with oxygen. The potential was cycled between +0.60 and −0.10 V at 40 mV/s.

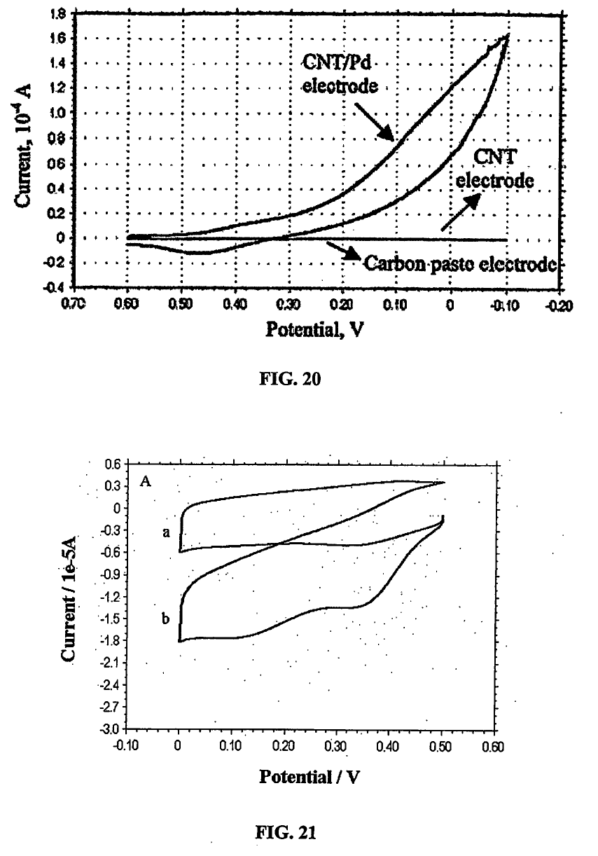

As shown in FIG. 20, essentially no O₂ reduction was observed over the potential window for the carbon-paste electrode containing the bare multiwalled carbon nanotubes or for the carbon-paste electrode containing the graphite powder. In contrast, with the carbon-paste electrode containing the Pd nanocomposites, a very large O₂ reduction wave was observed at potentials characteristic for Pd electrocatalysis. The enhancement of the cathodic current indicated a high electrocatalytic activity of the carbon-paste electrode containing the Pd nanocomposites for the reduction of oxygen.

### Example 13

### Testing the Catalytic Capability of Functionalized, Randomly-Oriented, Multiwalled Carbon Nanotubes Decorated with Rh and Ru Nanoparticles in Hydrogenation and Hydroformylation Reactions

The nanocomposites comprising highly dispersed Rh and Ru formed in Examples 5 and 6 also were tested for their catalytic activity in a variety of reactions. As a catalyst for the hydrogenation of trans-cinnamaldehyde and the hydroformylation of hex-1-ene in the liquid phase, Rh-supported multiwalled carbon nanotubes were found to be very selective toward C—C double-bond hydrogenation and the production of linear and branched aldehydes. Ru nanoparticles anchored on multiwalled carbon nanotubes showed an increase in selectivity (up to 92%) for cinnamyl alcohol in liquid-phase hydrogenation of cinnamaldehyde.

### Example 14

### Testing the Catalytic Capability of Functionalized, Randomly-Oriented, Multiwalled Carbon Nanotubes Decorated with Pd, Pt or Pt—Ru Nanoparticles in Oxygen Reduction and Methanol Oxidation Reactions on a Glassy Carbon Electrode

The electrocatalytic reactivity of Pd, Pt, and Pt—Ru modified carbon nanotubes was tested in an oxygen reduction reaction and a methanol oxidation reaction on a glassy carbon electrode surface. The nanocomposites were synthesized in supercritical carbon dioxide and characterized by TEM analysis. A 0.5 wt % Nafion solution was prepared by diluting a 5 wt % Nafion solution with water. Ultrasonic agitation in 1 mL of the 0.5% Nafion solution aided in dispersing the 1 mg samples. A homogeneous black solution was obtained. A 5 μL aliquot of this solution was cast onto a glassy carbon electrode surface. The glassy carbon electrode was 3 mm in diameter and obtained from BAS (West Lafayette, Ind.). Before surface modification, the glassy carbon electrode was polished with 3 and 0.05 μm alumina slurries, washed with water and acetone, subjected to ultrasonic agitation for 1 minute in ultrapure water and then dried under an air stream. The coating was dried at room temperature in the air for 1 hour. For comparison, a glassy carbon electrode with plain, undecorated carbon nanotubes was prepared by the same procedure and with the same amount of solution. The glassy carbon electrode surfaces were washed carefully with ultra-pure water before each measurement.

The electrocatalytic activity of the nanocomposites toward oxygen reduction was studied using the cyclic voltammetry method. Cyclic voltammetric experiments were performed with a CHI 660 electrochemical workstation obtained from CH Instruments Inc. (Austin, Tex.). All experiments were carried out with a conventional three-electrode system. The working electrode was glassy carbon electrode being tested. An Ag/AgCl (saturated by KCl solution) reference electrode was used for all electrochemical measurements. All of the potentials were reported versus this reference electrode. A Pt wire was used as a counter electrode. All of the electrochemical experiments were carried out at room temperature.

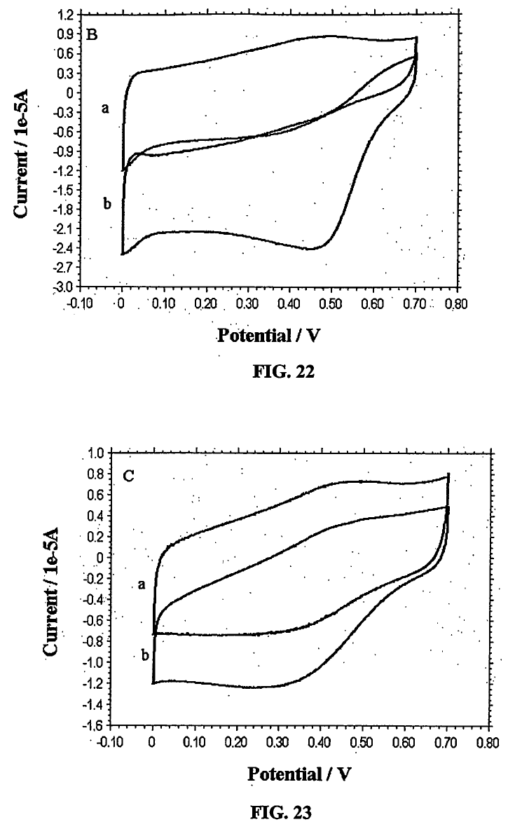

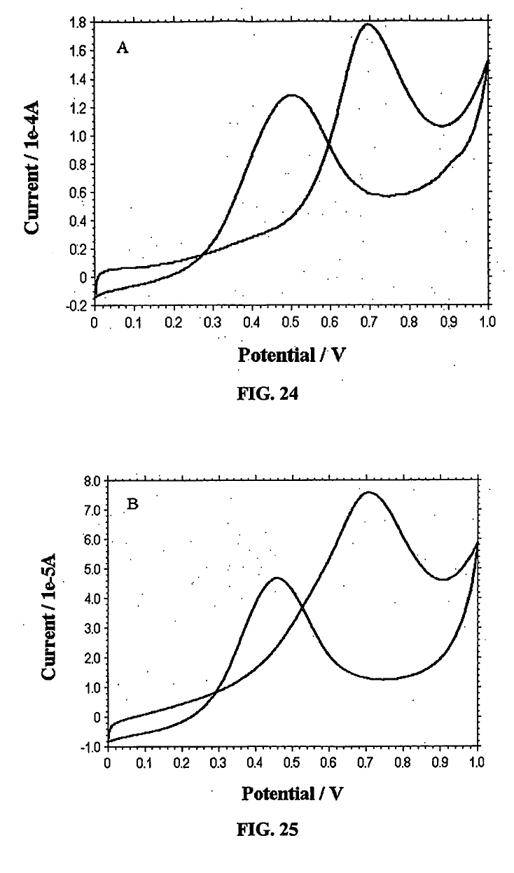

The experimental results revealed that the Pd decorated carbon nanotubes possessed a remarkable activity and high stability for the oxygen reduction reaction in an acid medium. The Pt—Ru and Pt carbon nanotubes possessed a remarkable activity and high stability for both the oxygen reduction reaction and the methanol oxidation reaction in the acid medium. FIGS. 21, 22 and 23 show typical cyclic voltammograms for the glassy carbon electrodes decorated with Pd, Pt and Pt—Ru, respectively, in the oxygen reduction reaction. The curves labeled “a” and “b” in FIGS. 21-23 represent the electrodes in 1M H₂SO₄ saturated by (a) nitrogen and (b) oxygen. The scan range was from 0.5 V to 0 V for the Pd sample and from 0.7 V to 0 V for the Pt and Pt—Ru samples, at a scan rate of 0.01 V/s. FIGS. 24 and 25 show typical cyclic voltammograms for the glassy carbon electrodes decorated with Pt and Pt—Ru, respectively, in the methanol oxidation reaction. The voltammograms were generated in a solution of 2 Molar CH₃OH+1 Molar H₂SO₄ at 0.05 V/s. The experiments were performed in 2 cycles, with the second cycle shown in FIGS. 24 and 25.

### OTHER EMBODIMENTS

Having illustrated and described the principles of the invention in exemplary embodiments, it should be apparent to those skilled in the art that the illustrative embodiments can be modified in arrangement and detail without departing from such principles. In view of the many possible embodiments to which the principles of the invention can be applied, it should be understood that the illustrative embodiments are intended to teach these principles and are not intended to be a limitation on the scope of the invention. We therefore claim as our invention all that comes within the scope and spirit of the following claims and their equivalents.

We claim:

1. A method, comprising:
mixing a precursor in a carrier,
transforming the precursor to form a metal or metallic compound after mixing the precursor in the carrier;
transporting the metal, metallic compound or precursor to a surface of a nanostructure substrate in the carrier while the carrier is in supercritical fluid form; and
forming a nanocomposite comprising the nanostructure substrate and the metal or metallic compound.

2. The method of claim 1, wherein the carrier is a gas at room temperature and atmospheric pressure.

3. The method of claim 1, wherein the carrier comprises carbon dioxide.

4. The method of claim 1, wherein the precursor comprises a metal-β-diketone complex and transforming the precursor comprises reducing the metal-β-diketone complex.

5. The method of claim 1, wherein the nanostructure substrate comprises substantially cylindrical nanostructures with a median diameter between about 2 nm and about 100 nm.

6. The method of claim 1, wherein the nanostructure substrate comprises a carbon nanotube.

7. The method of claim 1, wherein the nanostructure substrate comprises a nanowire.

8. The method of claim 1, wherein the nanostructure substrate comprises a pore of a mesoporous material.

9. The method of claim 1, further comprising separating the nanostructure substrate from the carrier, and wherein transforming the precursor comprises transforming the precursor on the surface of the nanostructure substrate after separating the nanostructure substrate from the carrier.

10. The method of claim 1, wherein transforming the precursor comprises transforming the precursor in the carrier to form free-floating nanoparticles comprising the metal or metallic compound, and the method further comprises:
mixing the carrier with a surfactant; and
depositing the nanoparticles onto the surface of the nanostructure substrate by reducing the temperature and/or pressure of the carrier.

11. The method of claim 1, wherein transforming the precursor comprises transforming the precursor in the presence of an organic capping ligand.

12. The method of claim 1, further comprising separating the nanocomposite from the carrier by reducing the temperature and/or pressure of the carrier.

13. The method of claim 1, wherein mixing the precursor with the carrier comprises dissolving the precursor in a solvent.

14. The method of claim 1, further comprising introducing a reducing agent into the carrier, and wherein transforming the precursor comprises reducing the precursor.

15. The method of claim 14, wherein the reducing agent is hydrogen.

16. The method of claim 1, wherein the surface of the nanostructure substrate is an external surface and further comprising functionalizing the surface of the nanostructure substrate to promote attachment of the metal or metallic compound.

17. The method of claim 16, wherein functionalizing the surface of the nanostructure substrate comprises oxidizing the surface of the nanostructure substrate.

18. The method of claim 1, further comprising depositing the metal, metallic compound or precursor in a hollow interior of the nanostructure substrate, wherein the nanostructure substrate comprises a carbon nanotube or a pore of a mesoporous material.

19. The method of claim 18, wherein the nanocomposite comprises a nanowire or nanorod within the hollow interior of the nanostructure substrate.

20. The method of claim 1, wherein the nanostructure substrate is attached to a common structure and substantially aligned with a plurality of similar nanostructure substrates.

21. The method of claim 20, wherein the nanostructure substrate comprises a carbon nanotube.

22. A method for forming a catalytic structure, comprising:
mixing a precursor in a carrier,
transforming the precursor to form catalytic nanoparticles comprising a metal or metallic compound after mixing the precursor in the carrier,
transporting the catalytic nanoparticles or precursor to a surface of a nanostructure substrate in the carrier while the carrier is in supercritical fluid form; and
forming a nanocomposite comprising the nanostructure substrate and the catalytic nanoparticles.

23. The method of claim 22, wherein the nanostructure substrate comprises a carbon nanotube.

24. The method of claim 22, wherein the nanostructure substrate is attached to a common structure and substantially aligned with a plurality of similar nanostructure substrates.

25. The method of claim 22, wherein the catalytic nanoparticles comprise a metal selected from group consisting of: Cu, Ag, Ni, Pt, Pd, Co, Au, Ir, Rh, Fe, Ru, and combinations thereof.

26. A catalytic structure, comprising:
a nanostructure support; and
catalytic metallic nanoparticles attached to the nanostructure support, wherein the catalytic metallic nanoparticles are substantially evenly distributed on the nanostructure support.

27. The catalytic structure of claim 26, wherein the nanostructure support comprises carbon nanotubes.

28. The catalytic structure of claim 26, wherein the nanostructure support comprises substantially cylindrical nanostructures with a median diameter between about 2 nm and about 100 nm.

29. The catalytic structure of claim 26, wherein the nanostructure support comprises nanowires.

30. The catalytic structure of claim 26, wherein at least a portion of a surface of the nanostructure support is functionalized to promote attachment of the catalytic metallic nanoparticles.

31. The catalytic structure of claim 26, wherein the catalytic metallic nanoparticles have a substantially uniform distribution of diameters with a median diameter between about 2 nm and about 12 nm.

32. A fuel cell that comprises the catalytic structure of claim 26 configured to catalyze oxygen reduction or methanol oxidation in the fuel cell.

33. The catalytic structure of claim 26, wherein the nanostructure support comprises carbon nanotubes attached to a common structure.

34. The catalytic structure of claim 33, wherein the carbon nanotubes are substantially aligned on the common structure.
